(19) United States
(12) Patent Application Publication
(10) Pub. No.: US 2022/0201422 A1
(43) Pub. Date: Jun. 23, 2022

(54) METHOD, APPARATUS AND COMPUTER PROGRAM PRODUCT FOR CONTROLLING TRANSMISSION OF SENSOR DATA AT THE EDGE OR NEAR-EDGE OF A NETWORK

(71) Applicant: HERE GLOBAL B.V., Eindhoven (NL)

(72) Inventors: Justin Eylander, Chicago, IL (US); Landis Mark Huffman, Chicago, IL (US); Yao Li, Chicago, IL (US); Brian Bilicki, Elk Grove Village, IL (US); Joshua Finken, Park City, UT (US); Amey Aroskar, North Aurora, IL (US)

(73) Assignee: HERE GLOBAL B.V., Eindhoven (NL)

(21) Appl. No.: 17/131,027

(22) Filed: Dec. 22, 2020

(51) Int. Cl. H04W 4/021; H04W 84/18; H04W 28/02; G06T 7/70

(52) U.S. Cl. CPC H04W 4/021; H04W 84/18; G06T 7/70; H04W 28/0268; H04W 28/0226

(57) ABSTRACT

A method, apparatus and computer program product are provided controlling transmission of sensor data. First sensor is processed to identify an area of interest and generate a trigger signal to direct the transmission of additional sensor data pertaining to the area of interest. Transmission of sensor data may be identified and/or prioritized based on various factors such as proximity, angle, orientation, interest level, category, rating, sensor type, sensor data quality and/or the like. Certain transmission characteristics may be controlled, directed and/or varied such as quantity, quality, rate of transmission, transmission frequencies and intervals, and/or the like. As such, user experience may be improved, and the consumption and timing of certain computation resources may be improved.

### TECHNOLOGICAL FIELD

An example embodiment relates generally to a method, apparatus and computer program product for controlling the transmission of sensor data, including at the edge or near-edge of a network.

### BACKGROUND

The advancement of computing technology has led to various types of sensors being used in various types of devices including user devices, smart watches, vehicles, weather stations, security systems, traffic monitoring systems, appliances, drones, and bodycams, among others. The Internet of Things (IoT) describes the network of such interconnected objects that routinely exchange data collected from a variety of sensors and systems to improve a breadth of consumer and industrial applications such as smart home technology, intelligent traffic systems, environmental monitoring, and/or the like.

The advancement of mobile communications has particularly enabled the expansion of ubiquitous computing, or technology everywhere. Technology consumers continue to demand data with low-latency and high qualities, which may strain a mobile network, particularly in a specific geographic area and during a major event or in response to an incident. The number of devices and/or sensors active within an area, along with network limitations relating to bandwidth, processing, and/or storage, may present challenges for a network access point (NAP) of a mobile network to facilitate the transmission of all data immediately as it becomes available, and at high qualities.

### BRIEF SUMMARY

A method, apparatus and computer program product are therefore provided in accordance with an example embodiment to control the transmission of sensor data at the edge or near-edge of a network, such as a mobile network.

Certain example embodiments may collect and analyze sensor data collected from a first sensor or group of sensors to identify an area of interest. The sensor data may include video data or images, which may be processed with scene assessment algorithms to detect an area of interest. The processing of the sensor data may occur at the edge or near-edge of a mobile network, such as by a multi-access edge computing (MEC) device implemented closer to a mobile device than the core network infrastructure.

For example, an image classification process may be implemented at the MEC device to determine that an image or video reflects an emergency, accident, or crime, and location data associated with the sensor data may be utilized to determine an area of interest. As another example, weather station sensors may register an extremely high temperature or high wind in a particular location. The MEC device may utilize various indicators and sensor data to identify an area of interest. In certain scenarios, the MEC device may prioritize such sensor data for transmission to the core network.

The MEC device may then generate a trigger signal in response to identifying the area of interest, such that additional sensor data associated with the area of interest is transmitted from additional user devices and/or mobile devices to the MEC device. For example, the MEC device may direct other devices in the vicinity of the area to transmit their respective sensor data. In certain example embodiments, a category or rating of an area of interest or event may be given such that data collected by sensors in the area may be prioritized over other, lower priority data.

Sensor data relating to areas or events of interest may therefore be transmitted to the MEC device (and in some instances the core network) with efficient timing and while conserving certain processing, memory, and/or networking resources of the core network. In this regard, resources of the core network may be dedicated or mostly dedicated to timely and efficiently providing sensor data relating to an area of interest such as an emergency or accident, without hindering the network by transmitting other or less important sensor data.

The MEC device may prioritize data transmission in a variety of ways. Data from certain sensor types may be prioritized over sensor data from other sensor types. Data from sensors may be prioritized based on proximity to an area of interest and/or the angle at which a sensor or associated device is positioned or facing relative to the area of interest. Certain example embodiments may further control, direct and/or vary characteristics of the sensor data transmission, dependent on its relation to the area of interest, and/or characteristic or rating of the area of interest). For example, data may be transmitted in variable quantities (e.g., number of readings or images) and/or from a variable number of sensors (e.g., from a calculating number of sensors and/or percentage of sensors active in an area). Data may be transmitted at variable qualities and/or rates, and at variable frequencies or intervals. Still further, certain data transmissions may be delayed or scheduled to provide a balance between consumer demand for sensor data, and constraints of the core network.

In certain examples, the MEC device may determine to prompt mobile devices and/or users in the area of interest to enable sensor data transmission from their device to encourage the provision of diverse sensor data capturing the area of interest as an emergency unfolds, sensor data captured from different perspectives of the area, and/or the like.

Implementing the prioritizations and varying the above described characteristics at the MEC device, implemented closer to a mobile device than the core network infrastructure, enables efficient identification of the area of interest and therefore timely collection of additional sensor data from the area. Example embodiments further enable the delivery of sensor data to end users with relatively low-latency, providing an improved user experience and timely delivery of sensor data.

An apparatus is provided, comprising at least processing circuitry and at least one non-transitory memory comprising computer program code instructions, the computer program code instructions configured to, when executed by the processing circuitry, cause the apparatus to generate a trigger signal in response to identifying an area of interest based on first sensor data provided by at least a first sensor. The computer program code instructions are further configured to, when executed by the processing circuitry, cause the apparatus to cause transmission of additional sensor data provided by at least one additional sensor associated with the area of interest, in response to the trigger signal. In certain example embodiments, identifying an area of interest comprises identifying an event of interest in the area of interest, and the trigger signal is generated in response to identifying the event of interest in the area of interest.

According to certain example embodiments, the first sensor data is transmitted via a routine data transmission process associated with the at least first sensor, and the additional sensor data is transmitted independently of any routine data transmission process associated with the at least one additional sensor. According to certain embodiments, the transmission of additional sensor data occurs in real-time or near real-time relative to the identification of the area of interest.

According to certain example embodiments, the computer program code instructions are further configured to, when executed by the processing circuitry, cause the apparatus to identify the additional sensor data by processing a temporal characteristic of at least one of the first sensor data or the additional sensor data in response to the trigger signal. The computer program code instructions may be further configured to, when executed by the processing circuitry, cause the apparatus to identify the at least one additional sensor by processing a data signal received in association with other sensor data to determine the at least one additional sensor as associated with the area of interest, in response to the trigger signal.

The computer program code instructions may be further configured to, when executed by the processing circuitry, cause the apparatus to prioritize transmission of the additional sensor data based on at least one of an associated proximity of a respective additional sensor to the area of interest, a characteristic of the area of interest, a rating of the area of interest, or a characteristic of the sensor data, wherein the characteristic of the sensor data comprises at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

In certain embodiments, the computer program code instructions are further configured to, when executed by the processing circuitry, cause the apparatus to control or vary at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

According to certain embodiments, the computer program code instructions are further configured to, when executed by the processing circuitry, cause the apparatus to identify the additional sensor data based on at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

In certain embodiments, the computer program code instructions are further configured to, when executed by the processing circuitry, cause the apparatus to identify the additional sensor data based on a camera angle relative to the area of interest.

Further in response to the trigger signal, the computer program code instructions are configured to, when executed by the processing circuitry, cause the apparatus to cause transmission of a request for consent to a user device associated with at least one unenrolled sensor associated with the area of interest. The computer program code instructions may be further configured to cause the apparatus to receive an indication of the consent via the user device, wherein the at least one additional sensor is associated with the user device, and wherein the transmission of the additional sensor data occurs in response to receiving the indication of the consent.

The computer program code instructions may be further configured to, when executed by the processing circuitry, cause the apparatus to further in response to the trigger signal, deprioritize, terminate, or prevent other data transmission. According to certain embodiments, the computer program code instructions are further configured to, when executed by the processing circuitry, cause the apparatus to identify at least a second area of interest associated with second sensor data, and prioritize transmission of data associated with the area of interest differently than transmission of data associated with the second area of interest based upon respective characteristics or ratings of the area of interest and the second area of interest.

The apparatus may be an edge computing device, and the computer program code instructions are further configured to, when executed by the processing circuitry, cause the apparatus to transmit the additional sensor data via a core network to one or more remote devices.

According to certain embodiments, the computer program code instructions are further configured to, when executed by the processing circuitry, cause the apparatus to cause a data transmission request to be broadcasted, via a local device associated with the area of interest, to a plurality of devices. The computer program code instructions are further configured to identify the at least one additional sensor in response to the broadcast, wherein the transmission of additional sensor data provided from the at least one additional sensor is performed in response to the broadcast.

A method is provided, including generating a trigger signal in response to identifying an area of interest based on first sensor data provided by at least a first sensor, and in response to the trigger signal, causing transmission of additional sensor data provided by at least one additional sensor associated with the area of interest. The method may further include identifying the additional sensor data by processing a temporal characteristic of at least one of the first sensor data or the additional sensor data.

In certain embodiments, the method includes identifying the at least one additional sensor by processing a data signal received in association with other sensor data to determine the at least one additional sensor as associated with the area of interest. The method may include prioritizing transmission of the additional sensor data based on at least one of an associated proximity of a respective additional sensor to the area of interest, a characteristic of the area of interest, a rating of the area of interest, or a characteristic of the sensor data, wherein the characteristic of the sensor data comprises at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

According to certain example embodiments, the method includes controlling or varying at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

The method may further include identifying the additional sensor data based on at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

The method may further include causing transmission of a request for consent to a user device associated with at least one unenrolled sensor associated with the area of interest, and receiving an indication of the consent via the user device, wherein the at least one additional sensor is associated with the user device, and wherein the transmission of the additional sensor data occurs in response to receiving the indication of the consent.

The method may further include deprioritizing, terminating, or preventing other data transmission in response to the trigger signal.

In certain embodiment, the method may further include causing a data transmission request to be broadcasted, via a local device associated with the area of interest, to a plurality of devices, and identifying the at least one additional sensor in response to the broadcast, wherein the transmission of additional sensor data provided from the at least one additional sensor is performed in response to the broadcast.

A computer program product is also provided, comprising at least one non-transitory computer-readable medium having computer-readable program instructions stored therein, the computer-readable program instructions comprising instructions, which when performed by an apparatus, are configured to cause the apparatus to generate a trigger signal in response to identifying an area of interest based on first sensor data provided by at least a first sensor. The computer-readable program instructions may further include instructions to cause transmission of additional sensor data provided by at least one additional sensor associated with the area of interest, in response to the trigger signal.

The computer-readable program instructions may further include instructions to, in response to the trigger signal, identify the additional sensor data by processing a temporal characteristic of at least one of the first sensor data or the additional sensor data. The computer-readable program instructions may further include instructions to, in response to the trigger signal, identify the at least one additional sensor by processing a data signal received in association with other sensor data to determine the at least one additional sensor as associated with the area of interest.

The computer-readable program instructions may further include instructions to prioritize transmission of the additional sensor data based on at least one of an associated proximity of a respective additional sensor to the area of interest, a characteristic of the area of interest, a rating of the area of interest, or a characteristic of the sensor data, wherein the characteristic of the sensor data comprises at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

The computer-readable program instructions may further include instructions to control or vary at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

According to certain example embodiments, the computer-readable program instructions may further include instructions to identify the additional sensor data based on a camera angle relative to the area of interest.

According to certain example embodiments, the computer-readable program instructions may further include instructions cause transmission of a request for consent to a user device associated with at least one unenrolled sensor associated with the area of interest, and instructions to receive an indication of the consent via the user device, wherein the at least one additional sensor is associated with the user device, and wherein the transmission of the additional sensor data occurs in response to receiving the indication of the consent. According to certain embodiments, the computer-readable program instructions may further include instructions to deprioritize, terminate, or prevent other data transmission in response to the trigger signal.

In certain embodiments, the computer-readable program instructions may further include instructions to identify at least a second area of interest associated with second sensor data, and prioritize transmission of data associated with the area of interest differently than transmission of data associated with the second area of interest based upon respective characteristics or ratings of the area of interest and the second area of interest.

In certain embodiments, the computer-readable program instructions may further include instructions to cause a data transmission request to be broadcasted, via a local device associated with the area of interest, to a plurality of devices, and identify the at least one additional sensor in response to the broadcast, wherein the transmission of additional sensor data provided from the at least one additional sensor is performed in response to the broadcast.

An apparatus is provided, with means for generating a trigger signal in response to identifying an area of interest based on first sensor data provided by at least a first sensor, and means for in response to the trigger signal, causing transmission of additional sensor data provided by at least one additional sensor associated with the area of interest. The apparatus may further include means for identifying the additional sensor data by processing a temporal characteristic of at least one of the first sensor data or the additional sensor data.

In certain embodiments, the apparatus includes means for identifying the at least one additional sensor by processing a data signal received in association with other sensor data to determine the at least one additional sensor as associated with the area of interest.

The apparatus may include means for prioritizing transmission of the additional sensor data based on at least one of an associated proximity of a respective additional sensor to the area of interest, a characteristic of the area of interest, a rating of the area of interest, or a characteristic of the sensor data, wherein the characteristic of the sensor data comprises at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

The apparatus may also include means for controlling or varying at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

### BRIEF DESCRIPTION OF THE DRAWINGS

Having thus described certain embodiments of the invention in general terms, reference will now be made to the accompanying drawings, which are not necessarily drawn to scale, and wherein:

FIGS. 1 and 2A are system diagrams depicting systems in which certain example embodiments may operate;

FIG. 2B is a block diagram illustrating an apparatus in accordance with an example embodiment of the present disclosure; and

FIGS. 3 and 4 are flowcharts illustrating operations performed in accordance with an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

As used herein, the terms “real-time” or “near real-time” may refer to a seemingly instant response time of one or more operations and/or data transfers occurring as a result of another operation and/or data transfer. However, it will be understood that certain delays for processing may be incurred. Reference to “near” real-time accounts for certain delays based on computer processing time and/or latency of data transmission based on network and/or other resource constraints or limitations. For example, real-time or near real-time responses performed on a server and/or local area network and/or the like may experience a processing delay of microseconds. However, data transmission occurring in real-time or near real-time over certain portions of a network may experience delays of microseconds, a few seconds, or even more, based on a variety of factors (e.g., network latency, network traffic, network bandwidth, data quality, processing time of an algorithm such as image processing algorithms, and/or the like). However it will be appreciated that reference to real-time or near real-time responses and/or data transmission is distinguished from operations and/or data transmission intentionally delayed and/or scheduled to occur in the future, as described in further detail herein.

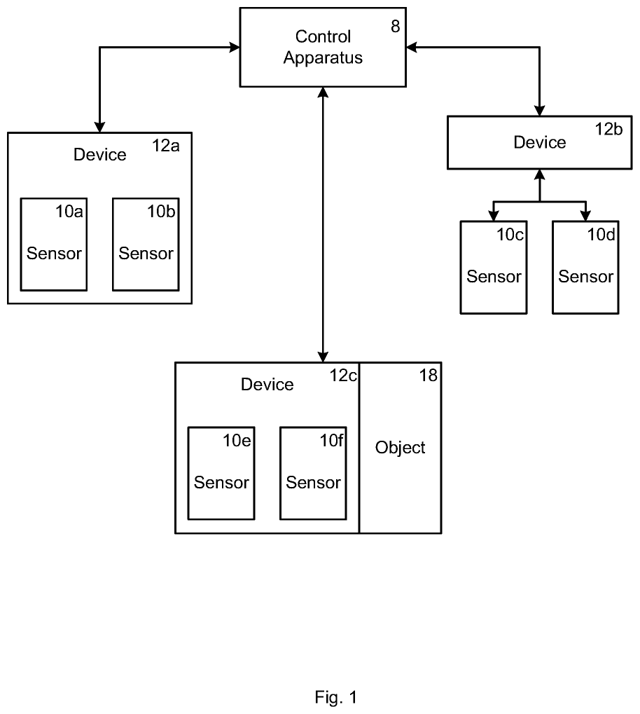

Referring to FIG. 1, a system in which certain example embodiments operate is depicted. In general, the illustrated embodiment of FIG. 1 includes a control apparatus 8 in data communication with a variety of sensors 10 including sensors 10a-10f. In certain example embodiments, data communication between the control apparatus 8 and sensors 10 may occur directly, and in certain example embodiments data communication may occur via device(s) 12, such as device 12a, device 12b and/or device 12c. Device 12 may include any apparatus or system such as a security system or camera, a traffic monitoring system, a weather station, household appliance, drone, bodycam, computing device (e.g., mobile computing device, personal computing device, smart watch, etc.) and/or the like. Additionally or alternatively, device 12 may include any device configured to communicate data to and/or from a vehicle over a network, such as but not limited to a navigation system, a vehicle control system, and/or a mobile computing device.

Device 12a reflects example embodiments in which one or more sensors, such as sensor 10a and 10b are comprised in the apparatus communicatively connected to control apparatus 8. For example, device 12a may be embodied by a mobile device that includes a variety of sensors 10 such as a camera, accelerometer, microphone, and/or the like.

Device 12b reflects example embodiments in which sensors, such as sensors 10c and 10r are in data communication with a device 12b which facilitates communication of data between control apparatus 8, and one or more sensors such as sensors 10c and 10d, among other functionality. For example, device 12b may include a vehicle control system that communicates data from various sensors configured in a vehicle, over a network to control apparatus 8. In certain embodiments, device 12b may be communicatively connected to sensors such as sensors 10c and/or 10d via various local network types, described in further detail herein.

In certain example embodiments, one or more sensors, such as sensors 10e and 10f may be embodied in a device 12c. A device 12, such as device 12c may further include other components such as a structural housing to incorporate sensors 10 into the device 12 which can be embedded in, attached to, or integrated with another apparatus and/or another object such as object 18. In certain embodiments, the device 12 such as device 12c may be attached to, removably attached to, and/or built into apparatus and/or another object such as object 18 such as a specific type of device. A sensor 10 and/or device 12 such as device 12c may be included in an object 18 such as a human, an animal and/or the like. The device 12, such as device 12c may therefore be referred to as a modular sensor device, and/or the sensors 10 such as sensors 10e and 10f may be considered modular sensors.

The devices 12 such as device 12a, 12b, and/or 12c described above are provided merely as examples, and it will be appreciated that device 12 may include a variety of other type of apparatuses, computing systems, and/or the like configured to comprise or communicate with a sensor(s) 10.

A sensor 10 may comprise any type of sensing and/or detection device including but not limited to, a motion sensor, a motion detector, a radar detection device, a hygrometer, a camera, a microphone, a radio, an accelerometer, a heart rate sensor, a physiological sensor, a biological sensor, a galvanized skin sensor, a neurological sensor, a temperature sensor, a location detection sensor, and/or any other sensor such as environmental condition sensors and/or the like. In certain example embodiments the sensor 10 may include a location sensor such as a global navigation satellite system (GNSS) related sensor, global position system (GPS) related sensor, and/or the like. A sensor 10 may further comprise sensors associated with a vehicle such as a tire pressure sensor, a lane departure sensor, a steering angle sensor, an airbag sensor, blind spot detection sensor, a collision sensor, a skid sensor, a braking sensor, a fuel level sensor, an oil status sensor, oil pressure sensor, engine/coolant temperature sensors, and/or the like. A sensor 10 may further include a long, medium, and/or short-range radio detection and ranging (RADAR), ultrasonic sensors, a light detection and ranging (LiDAR) sensor, an infrared sensor, an electromagnetic sensor, and/or the like. Any type of sensor, including variations and combinations of the aforementioned sensors may be contemplated and incorporated into the system of FIG. 1 and/or utilized according to certain example embodiments.

In general, the sensors 10 may be configured to collect data and signals from the surrounding environment, a device 12, an object 18, and/or a user, and provide the sensor data as directed by processing circuitry and via a communication interface (described in further detail below) to control apparatus 8. The data collected by a sensor 10 may be transmitted via a network in which control apparatus 8 is operative, for processing and/or utilization by other devices in the network, for consumption by end users, and/or the like. According to certain embodiments described herein, the control apparatus 8 may at least partially direct what sensor data, and/or from what sensors or sensors types sensor data may be transmitted. Additionally or alternatively, the control apparatus 8 may further direct or control transmission characteristics such as but not limited to at what time intervals or frequencies, rates, and/or qualities the sensor data is transmitted.

It will be appreciated that FIG. 1 is provided merely as an example and that other configuration of sensors 10 in data communication with control apparatus 8 may be contemplated.

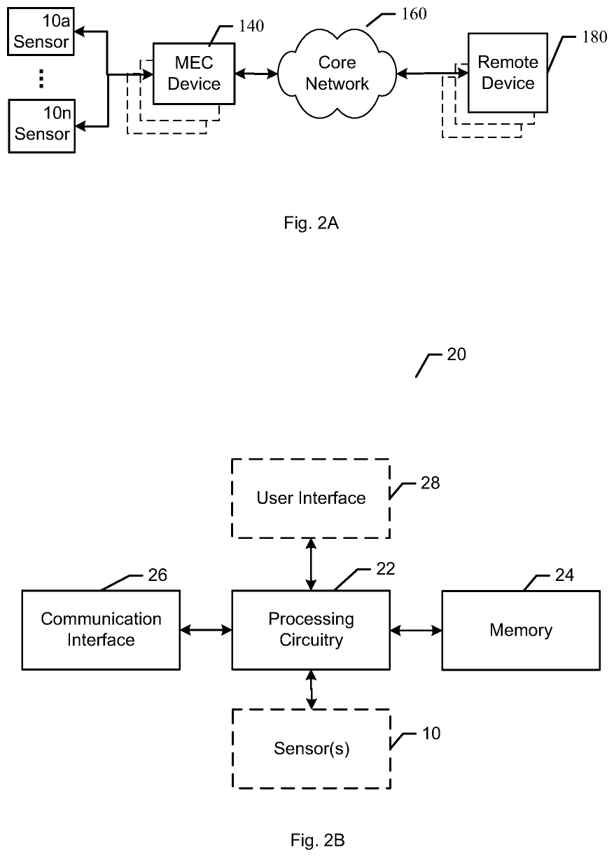

FIG. 2A is an example diagram of a multi-access edge computing (MEC) system and depicts a system and network in which certain example embodiments may operate. Various architectures of a system and/or network in which the control apparatus 8, and sensors 10 are implemented may be contemplated. For example, the system may be implemented according to a 3^{rd} Generation Partnership Project (3GPP) network architecture, a non-3GPP network architecture, and/or the like.

In the system of FIG. 2A, the control apparatus 8 may be implemented at a MEC device 140, which may be a server (e.g., MEC server) and/or subsystem deployed at a base station of a cellular network, such as a core network 160. According to certain embodiments, the MEC device 140 may be referred to as a “MEC.” As indicated by the dashed lines in relation to the MEC device 140 of FIG. 2A, multiple MEC devices 140 may be implemented in various locations throughout a network. Sensor data collected by various sensors 10 such as sensors 10a-10n may be transmitted to the MEC device 140 via optional device(s) 12 (not depicted in FIG. 2A). Data, including sensor data and other data, may be transmitted between sensors 10, user equipment (including but not limited to device 12), and/or the like, and the MEC device 140 via a wireless access point (WAP), access node, radio access point, a radio terminal, and/or the like.

The core network 160 may comprise communication facilities that interconnect primary nodes of access networks. The core network 160 may further be configured to route or exchange data among various sub-networks. The core network 160 may be any suitable core network structure such as an evolved packet core (EPC) network, a general packet radio system (GPRS) core network, or the like. The core network 160 may be implemented according to 3GPP 5G technology, and/or the like, and may utilize virtualized network functions.

The MEC device 140 may access the core network 160 via a core network gateway, configured to receive a request for services, applications, and/or data from the MEC device 140 and route the request to the core network. A multi-access edge orchestrator (MEO) may be configured to manage and control requests for services, applications, and/or data amongst components of the network such as the MEC device 140 and/or core network 160 (e.g., via the core network gateway).

The core network 160 may further provide access to a variety of other interconnected computer networks with transmission control protocol (TCP)/internet protocol (IP) based networking protocols and/or the like. The core network 160 may therefore facilitate communication to a variety of services and information available via the Internet. Accordingly, data provided by sensors 10 may be communicated over the network depicted in FIG. 2A to various remote devices 180, such as user devices, servers, related computing systems, and/or the like.

The architecture depicted in FIG. 2A enables data to be processed at the edge or near-edge of a mobile network (at the MEC device 140) such that application developers and consumers can enjoy cloud-computing capabilities with low latency and high bandwidth as well as real-time or real-time access to radio network information. Despite advanced broadband cellular core networks, such as but not limited to 3GPP 5G networks, which may offer increased bandwidth and lower latency relative to its predecessors, localizing certain processing functionality at the MEC device 140 may provide numerous advantages such as improved efficiency, improved distribution and/or control of resource consumption, and improved user experience, as described in further detail herein. It will be appreciated that certain operations described herein as occurring at the “edge” or “near-edge” of a mobile network may be performed at the MEC device 140. The term edge or near-edge may be used to emphasize that other components of a network may be implemented in any portion of the network, but that in any event, implementing certain operations at the MEC device 140, separate from the core network 160, may provide certain advantages.

The MEC device 140 may therefore be utilized by a variety of applications including image analysis applications, location service applications, IoT applications, local content distribution applications, data caching applications, and/or the like. According to certain example embodiments provided herein, when the MEC device 140 implements the control apparatus 8, sensor data may be processed at the MEC device 140, to identify areas of interest, including but not limited to events occurring in an area of interest. The control apparatus 8 (e.g., MEC device 140) may further control or direct transmission of additional sensor data according to identified areas of interest, as described in further detail below.

It will be appreciated that various modifications may be made to the network of FIG. 2A. In certain example embodiments, the network may also include a variety of sub-networks, such as a wireless local area network (WLAN), a wireless fidelity (Wi-Fi) network, a near field communication network (e.g., Bluetooth® communication network), and/or the like. For example, sensors 10 may communicate to a separate device, such as device 12 (not illustrated in FIG. 2) via a WLAN, Wi-Fi network, near field communication (NFC) network and/or the like, which in turn communicates to the MEC device 140. Other variations may be contemplated.

As shown in FIG. 2B, an apparatus 20 is provided in accordance with an example embodiment, for implementing the control apparatus 8, device 12, MEC device 140, and/or remote device 180. The apparatus 20 of certain example embodiments, such as the device 12, control apparatus 8, MEC device 140, remote device 180, and/or the like may be embodied by any of a wide variety of different computing devices including, for example, a server, a computer workstation, a personal computer, a desktop computer or any of a wide variety of computing devices, distributed system and/or networked sub-system. For example, apparatus 20 may comprise or implement a security system, a traffic monitoring system, a weather station, a household appliance, a navigation system, vehicle control system, and/or other computing device.

In certain embodiments, the apparatus 20 embodying any of the device 12, and/or remote device 180, may be embodied by a wide variety of personal computing devices including but not limited to a personal computer, a laptop computer, a mobile device, a smart watch, a bodycam and/or other wearable device, among others.

Regardless of the type of computing device that embodies the apparatus 20, the apparatus of an example embodiment includes, is associated with, or is in communication with processing circuitry 22, memory 24 and communication interface 26. A user interface 28 may be included in apparatus 20 when the apparatus is embodied by a user device (e.g., device 12, remote device 180, etc.), but may be optional when apparatus 20 is embodied by a control apparatus 8 and/or MEC device 140. The sensor(s) 10 may be included in apparatus 20 when the apparatus is embodied by device 12, and may be optional when apparatus 20 is embodied by a control apparatus 8, MEC device 140, and/or remote device 180.

In some embodiments, the processing circuitry 22 (and/or co-processors or any other processors assisting or otherwise associated with the processing circuitry) may be in communication with the memory device 24 via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processing circuitry.

In certain embodiments, processing circuitry 22 may be configured to process sensor data received from sensor 10, and process the sensor data with computer program code stored on memory device 24, as described in further detail herein. Certain aspects of such processing may occur on the device 12 and/or control apparatus 8, such as the MEC device 140.

The processing circuitry 22 may be embodied in a variety of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processor may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 22 may be configured to execute instructions stored in the memory device 24 or otherwise accessible to the processing circuitry. Alternatively or additionally, the processing circuitry may be configured to execute hard coded functionality. As such, whether configured by hardware or software methods, or by a combination thereof, the processing circuitry may represent an entity (for example, physically embodied in circuitry) capable of performing operations according to an embodiment of the present invention while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of software instructions, the instructions may specifically configure the processing circuitry to perform the algorithms and/or operations described herein when the instructions are executed. However, in some cases, the processing circuitry may be a processor of a specific device (for example, a computing device) configured to employ an embodiment of the present invention by further configuration of the processor by instructions for performing the algorithms and/or operations described herein. The processing circuitry may include, among other things, a clock, an arithmetic logic unit (ALU) and logic gates configured to support operation of the processing circuitry.

The apparatus 20 of an example embodiment may also optionally include a communication interface 26 that may be any means such as a device or circuitry embodied in either hardware or a combination of hardware and software that is configured to receive and/or transmit data from/to other electronic devices in communication with the apparatus, such as any of the components of FIG. 1 and/or FIG. 2A. Additionally or alternatively, the communication interface may be configured to communicate in accordance with various wireless protocols including Global System for Mobile Communications (GSM), such as but not limited to Long Term Evolution (LTE). In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In this regard, the communications interface 26 of a device 12 may facilitate the transmission of sensor data to the communication interface 26 of control apparatus 8, MEC device 140, and/or the like, which may further facilitate the transmission of sensor data to various components in a network.

The apparatus 20 of an example embodiment may also optionally include a user interface 28 that provides an audible, visual, mechanical, or other output to the user. As such, the user interface 28 may include, for example, a keyboard, a mouse, a display, a touch screen display, a microphone, a speaker, and/or other input/output mechanisms. As such, the user interface 28 may, in some example embodiments, such as when apparatus 20 is embodied by remote device 180, provide means for provision of sensor data and/or information relating thereto. When apparatus 20 is embodied by device 12, the user interface 28 may provide means to provide user instructions, confirmations, and/or the like pertaining to the collection of sensor data, and/or may provide means to enable user input to consent to the capture of sensor data and transmission thereof In some example embodiments, aspects of user interface 28 may be limited or the user interface 28 may not be present.

The apparatus 20 of certain example embodiments, such as device 12a and/or device 12c, may comprise any number of sensor(s) 10 configured to capture sensor data for further processing by processing circuitry 22 and/or transmission via communication interface 26.

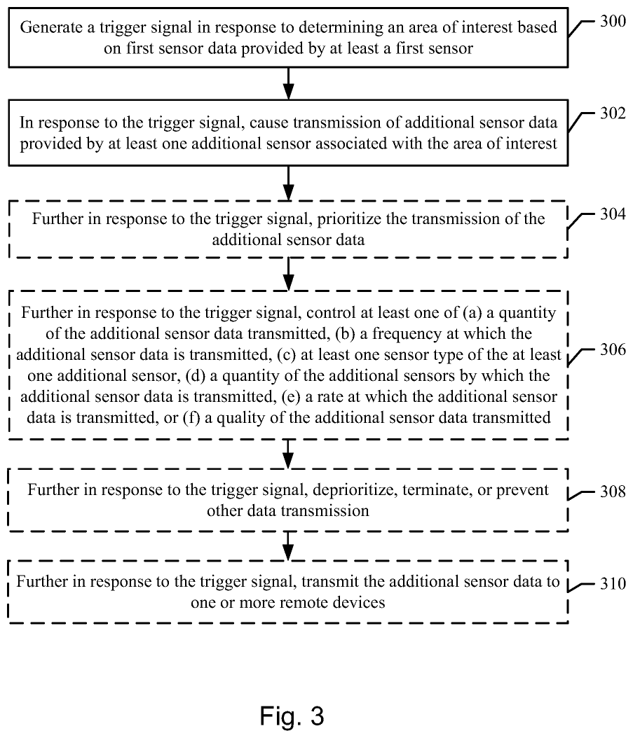

Having now described the apparatus of certain example embodiments, FIG. 3 is a flowchart of operations that may be performed according to certain example embodiments. The operations of FIG. 3 may be performed by a control apparatus 8, MEC device 140, and/or the like. As shown by operation 300, apparatus 20 may include means, such as the processing circuitry 22, memory device 24 communication interface 26, and/or the like, for generating a trigger signal in response to identifying an area of interest based on first sensor data provided by at least a first sensor.

Reference to first sensor data is made to distinguish the sensor data from additional sensor data collected as described herein. The first sensor data may be transmitted via a variety of methods. The first sensor data, may in certain example embodiments, be collected at the control apparatus 8 and/or MEC device 140 as a part of a routine data transmission process. For example, certain users, and/or device 12, may have provided consent for data, such as but not limited to sensor data, to be transmitted over a network. Such transmission may be associated with continuous capture functionality and/or may result in data being transmitted every 5 seconds, daily, or on any other time interval and/or frequency. As yet another example, a user may direct uploading of sensor data to the control apparatus 8 and/or MEC device 140 using one or more application services and/or the like. Still further, vehicles may transmit a variety of data, which may occur in certain instances such as when the vehicle is on or moving, and/or if certain threshold speeds and/or other conditions are met.

In certain example embodiments, an application operative on the device 12 may process and/or filter sensor data prior to transmission to the control apparatus 8 and/or MEC device 140. In this regard, certain thresholds may be used to determine if sensor data collected by the device 12 is “interesting” or may potentially relate to an “area of interest.” It will be appreciated that regardless of the determination occurring at the device 12, control apparatus 12 and/or MEC device 140 (as described in further detail below), processing circuitry 22 may process various sensor data types such that various thresholds or conditions for the sensor data as interesting, or example embodiments may determine an associated area as an area of interest. The operations described herein pertaining to analysis and/or processing of sensor data may therefore be distributed and/or divided amongst various components. For example, some sensor data processing may occur at the device 12, while other or additional sensor data processing may occur at the control apparatus 8 and/or MEC device 140. In certain embodiments, no filtering and/or processing of sensor data may occur at the device 12, such that the processing of sensor data described herein occurs only at the control apparatus 8 and/or MEC device 140. Various configurations may be contemplated.

A minimum or maximum threshold of any criteria relating to sensor data may be satisfied or exceeded to identify the sensor data as interesting (at the device 12, control apparatus 8, and/or MEC device 140). Still further, multiple instances of sensor data from a common or similar location and/or timeframe may need to satisfy such thresholds or conditions for an area of interest to be identified. In certain example embodiments, various ratings, scores, and/or categories may be associated with sensor data. For example, sensor data could be rated or scored on a 1-100 scale of interest level, and/or classified as “un-interesting,” “interesting,” “very interesting,” and/or the like. Still further, an area of interest may be determined as being associated with an event, such as based on certain determinations and/or classifications. Example of an event may include a car accident, an emergency related event, a crime, a weather event, a natural disaster, a social event, a crowd-related event, and/or the like. It will be appreciated that as referenced herein, an area of interest may be interpreted to include or relate to an event occurring in or near the area of interest.

In any event, processing circuitry 22 may process sensor data, such as the first sensor data, to determine an area of interest using various methods and/or algorithms. In certain example embodiments, identifying an area of interest may include determining sensor data is interesting and/or reflects an area of interest, and determining and/or defining the area associated therewith. Various methods and thresholds for assessing interest may be contemplated, and may be performed at the device 12, control apparatus 8, MEC device 140, and/or any combination thereof.

For example, if the sensor data includes images and/or video, processing circuitry 22 of example embodiments may utilize image processing techniques such as but not limited to scene assessment, scene analysis, object recognition, pose detection, motion detection, image classification, and/or the like to determine the sensor data is of interest. Audio data reflecting certain sound volumes, characteristics and/or the like may be indicative of an area of interest. Weather related sensor data, environment related sensor data, vehicle sensor data and/or the other sensor may be processed to determine an area of interest. In certain example embodiments, machine learning methodologies may be used to train the processing circuitry 22 of example embodiments to detect an area of interest based on sensor data labeled (e.g., with a rating, score, and/or classifier, for example), then utilize the associated model to predict area of interest based on sensor data. A variety of other sensor data types, and corresponding methods and/or thresholds may be used to determine an area of interest.

In an instance in which sensor data is processed at the device 12, and the sensor data is classified as interesting, the sensor data may be transmitted to control apparatus 8 and/or MEC device 140 and further processed as described below (to assess other sensor data to determine or confirm an area of interest, and/or to direct transmission of additional sensor data pertaining to the area of interest). In certain embodiments, if the sensor data is classified as non-interesting at the device 12, the sensor data may not be transmitted to the control apparatus 8 and/or MEC device 140. In this regard, a first threshold for determining a level of interest may be implemented at the device 12, and/or a different or second high threshold for determining a level interest may be implemented at the control apparatus 8 and/or MEC device 140. A variety of methods may be contemplated for directing transmission of the first sensor data from device 12 to control apparatus 8 and/or MEC device 140.

According to certain example embodiments, the apparatus 20, such as with processing circuitry 22, may identify an area of interest according to sensor data collected from one sensor 10. However, in certain embodiments, the area of interest may be determined by control apparatus 8 and/or MEC device 140 based on sensor data from a plurality of sensors 10 and/or devices 12, such as those located in, proximate to, or nearby an area of interest. In certain example embodiments, sensor data from one sensor 10 may not satisfy a threshold for identifying an area of interest, but sensor data from several sensors 10 associated with a common or similar location, when considered in combination, may satisfy a threshold for identifying an area of interest such that an area of interest is identified and a trigger signal is generated. Additionally or alternatively, the control apparatus 8 and/or MEC device 140 may perform more accurate and/or precise scene analysis scene assessment, scene reconstruction and/or the like, to more accurately predict an area of interest, based on sensor data collected from a plurality of sensors in an area. Still further the processing circuitry 22 of example embodiments may make predicts or determinations with regard to any feasible area of interest and/or event, such as but not limited to identifying vehicle stopped at an intersection, an emergency event (g., accident or natural disaster), a social gathering (e.g., a street festival temporarily blocking traffic), among other possibilities.

According to certain embodiments, control apparatus 8 and/or MEC device 140 may estimate the area of interest by extrapolating location data and/or other location indicators associated with various sensor data. As referenced herein, proximity may relate to the location of a sensor 10, and/or device 12, relative to the area of interest, and optionally at a time the associated sensor data was collected, transmitted by sensor 10, and/or device 12 and/or received by control apparatus 8 and/MEC device 140. In this regard, an area of interest may be identified as pertaining to an event or incident lasting a certain period of time, which may also be determined according to example embodiments.

In certain embodiments, processing circuitry 22 of example embodiments, may determine and/or define the area of interest by a specific geographic area of interest. The area of interest and geographic area of interest may be the same and may be referenced herein interchangeably. A geographic area of interest may be defined based on geographic coordinates, addresses, mapped node data, city blocks, buildings and/or the like. The processing circuitry 22 may utilize location and/or positioning data, such as provided by a GPS, GPSS, probe devices, and/or other sensors and/or systems associated with the device 12 from which the first sensor data was captured and/or transmitted. Example embodiments may additionally or alternatively determine location and/or positioning data based on a variety of methods and/or data, such as by using data obtained from a beacon, a radar system, a Wi-Fi network, and/or the like. In certain embodiments, geographic locations may be extrapolated based on indications that sensor data was collected via Bluetooth® communication technology. Still further, geographic locations may be estimated and/or determine based on inertial measurement systems, trajectories based on vehicle probes, and/or the like.

Map matching techniques may be used to optionally match location data to a mapped geographic area according to a master geographic database, navigation database and/or the like, which may be downloaded and/or stored at the control apparatus 8 and/or MEC device 140. The map database and/or portions thereof may also be installed at the device 12. The map data may include node data, road segment data or link data, point of interest (POI) data or the like. The database may also include cartographic data, routing data, and/or maneuvering data. According to some example embodiments, the road segment data records may be links or segments representing roads, streets, or paths. The map data may include various attributes of road segments and/or may be representative of sidewalks or other types of pedestrian segments, as well as open areas, such as grassy regions or plazas. The node data may be end points corresponding to the respective links or segments of road segment data. The link data and the node data may represent a road network, such as used by vehicles, cars, trucks, buses, motorcycles, and/or other entities. Optionally, the database may contain path segment and node data records or other data that may represent bicycle lanes, pedestrian paths or areas in addition to or instead of the vehicle road record data, for example. The link segments and nodes can be associated with attributes, such as geographic coordinates, street names, address ranges, and other navigation related attributes, as well as POIs, such as fueling stations, hotels, restaurants, museums, stadiums, offices, buildings, stores, parks, etc. The database can include data about the POIs and their respective locations in the POI records. The database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database, and/or may be updated to include a geographic area of interest as determined according to example embodiments. In such embodiments, a geographic area of interest may be defined in a map database as having an associated time range, such as associated with an event of interest. It will be appreciated that any reference to an area of interest may optionally further indicate an event, or event of interest.

According to example embodiments, the location and positioning data, map data, and/or the like, is utilized in a manner that enables sensor data to be associated with a geographic area. In addition to, or alternatively to the sensor data having associated location data, such as GPS location, the sensor data may also have an associated identifier, such as a device identifier, that identifies the device and/or apparatus that provides the sensor data and enables the linking of different instances of sensor data provided from the same device, identification of vehicle trajectories, and/or the like. However in some embodiments, anonymity of the source of the sensor data may be maintained.

An example embodiment may utilize any method for the device 12 and/or sensor 10 for reporting its respective location at the time the sensor data was captured and/or transmitted. Additionally or alternatively, the control apparatus 8 and/or MEC device 140 may detect a location of a device, such as device 12 at the time the sensor data was collected, and/or the sensor data may have a timestamp associated therewith that is transmitted with the sensor data or in associated with the sensor data.

In certain embodiments, processing circuitry 22 of apparatus 20 may use data relating to the orientation of device 12. For example, an angle of a camera and/or other device at the time sensor data is collected may be utilized to determine an area of interest based on the location and/or positioning data, and may further determine the area of interest as an area or space in a certain direction and/or angle from the device's location at the time sensor data was collected and/or transmitted. An accelerometer or other such sensor may therefore be utilized. As another example, positioning and/or orientation data associated with the sensor data may be referenced. Still further, probe data, vehicle trajectories, and/or other data indicative of positioning, orientation, and/or location may be utilized.

As yet another example, an area of interest need not be defined by explicit geographic and/or map-based data, but may be defined as an area in which certain devices may communicate over a certain network type and/or communication protocol. For example, devices within range for NFC with a local device and/or server may be considered to define the area of interest. Accordingly, the area of interest need not be expressly defined by a geographic boundary, but may be indirectly defined based on certain communication technologies or capabilities such as those described in further detail below, and may be particularly beneficial for real-time and/or near real-time broadcasting of communications to and/or from an area of interest or associated therewith. In this regard, when performing operation 300, determining an area of interest may refer to the determination of existence of an area of interest with regard to the first sensor data, and optionally but not necessarily the associated geographic area associated with the area of interest (e.g., geographic area of interest).

The above example methods and/or data used to determine an area of interest are provided merely as examples. Various methods and/or combinations thereof may be contemplated to identify, determine and/or define an area of interest based on sensor data provided from at least a first sensor.

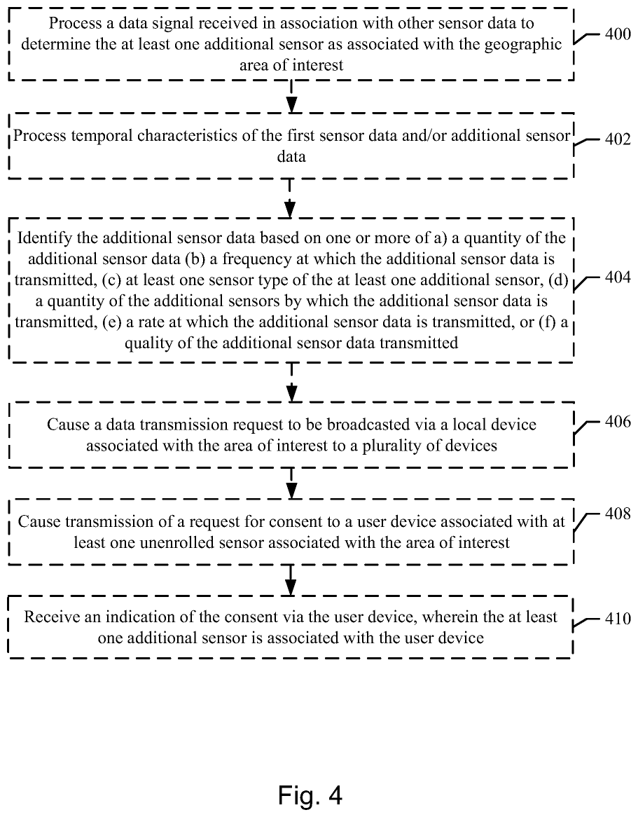

As shown by operation 302, apparatus 20 may include means, such as the processing circuitry 22, memory device 24, communication interface 26, and/or the like for causing transmission of additional sensor data provided by at least one additional sensor associated with the area of interest. The additional sensor data may be determined and/or identified in a variety of ways. The flowchart of FIG. 4 provides optional operations, as indicated by the dashed lines, for identifying the at least one additional sensor and/or additional sensor data associated with the area of interest. In general, control apparatus 8 and/or MEC device 140 may define a geographic area of interest, and then determine device(s) 12 that are in the vicinity of the geographic area of interest, or additional sensor data identified as having been captured in association with the geographic area of interest. However, in certain embodiments, a geographic area of interest, geographic coordinates, and/or explicit geographic boundary need not be defined, and control apparatus 8 and/or MEC device 140 may direct broadcasting of signals in the area of interest such that device(s) 12 within range of the broadcasted signal (and/or their associated sensors and/or sensor data) may be inherently identified as associated with the area of interest. In any event, FIG. 4 depicts certain example operations that may be practiced to identify, determine, or obtain the additional sensor data.

As shown by operation 400, apparatus 20 may include means, such as the processing circuitry 22, memory device 24, communication interface 26, and/or the like for processing a data signal received in association with other sensor data to determine the at least one additional sensor as associated with the area of interest. In this regard, data transmitted to the control apparatus 8 and/or MEC device 140 from other sensors 10, such as via device 12 associated with the first sensor data described with respect to operation 300, and/or other device 12 not associated with the first sensor data), may be processed to determine location and/or positioning data, and optionally matched to a map database, according to any of the methods described above.

According to certain embodiments, processing circuitry 22 may utilize probe data (and/or other sensor data indicative of position and/or location) collected at a control apparatus 8 and/or MEC device 140 to identify certain devices in a certain location in real-time or near real-time. Example embodiments may therefore identify additional devices and/or additional sensors proximate to or associated with the area of interest. The control apparatus 8 and/or MEC device 140 may therefore direct transmission of the additional sensor data from such devices as described in further detail below.

Various modifications may be contemplated. For example, additional sensors within a threshold distance or range of a geographic area of interest may be identified, and may be optionally identified based on the angle or orientation of the additional sensor and/or associated device 12. As another example, trajectories of moving vehicles may be used to identify additional sensors approaching the area of interest. In this regard, example embodiments may obtain sensor data relating to the area of interest captured from various perspectives.

As shown by operation 402, apparatus 20 may include means, such as the processing circuitry 22, memory device 24, communication interface 26, and/or the like for processing temporal characteristics of the first sensor data and/or other sensor data. In this regard, additional sensor data identified with respect to operation 302 and/or 400 may need not only be associated with the area of interest, but may be have a certain temporal characteristic associated with the first sensor data, such as the sensor data having been captured with a certain time range of each other, and/or the locations of the sensors 10 and/or devices 12 being with a certain geographic area or within range of each other during a certain time period, and therefore optionally associated with an event, incident, natural disaster and/or the like.

In certain example embodiments, a temporal characteristic may not need to be assessed. For example, in instances in which first sensor data is processed in real-time or near real-time, and a trigger signal generated accordingly, other sensor data received within a similar or a same time range inherently has a similar temporal characteristic with the first sensor data, such that time stamps and/or other temporal indicators may not need to be processed.

As yet another example, processing circuitry 22 of an example embodiment may determine additional sensor data based on temporal data associated intentionally identified as having been captured at a time spaced from (earlier than or later or) the capture of temporal data associated with the first sensor data. For example, example embodiments provided herein may be utilized to monitor stability and/or deterioration of a road condition, such as a pothole, and/or other conditions reflected by sensor data collected over a relatively longer term (and optionally less frequently) than the sensor data that may be processed relating to an event, and/or other scenario in which real-time or near real-time processing is desired.

Additionally or alternatively, if the first sensor data is received and is determined to be associated with a time in the past, the processing circuitry 22 of an example embodiment may assess additional sensor data having any desired temporal characteristic. For example historical sensor data may be identified to enable reconstruction of events leading to another event or condition. For example, if the first sensor data is received and is determined to be associated with a time in the past as opposed to real-time or in near real-time, and is further identified as associated with an area of interest and/or event, additional sensor data having a similar temporal characteristic (e.g., captured within a certain time frame as the first sensor data) may be identified. Accordingly, various implementations of using temporal data may be contemplated.

In any event, both location and time may be factors in identifying the at least one additional sensor and/or sensor data. In certain embodiments, location may be a factor in identifying the at least one additional sensor, and time may be inherently considered by way of real-time or near real-time broadcasts as described in further detail below.

Processing circuitry 22 of apparatus 20 may identify additional sensor data in a variety of ways. As shown by operation 404, apparatus 20 may include means, such as the processing circuitry 22, memory device 24, communication interface 26, and/or the like for identifying the additional sensor data based on one or more of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, and/or (f) a quality of the additional sensor data transmitted. Any of the characteristics described herein, including but not limited to the aforementioned characteristics (a)-(f), proximity, and/or temporal characteristic may be assessed and/or weighted differently. In certain embodiments, characteristics (a)-(f) may be assessed and/or weighted differently according to proximity to the area of interest, a temporal characteristic, a characteristic and/or rating of the area of interest, and/or the like.

The quantity may refer to the number of readings from a sensor, number of captured images, duration of video signals, duration of audio signals and/or the like. For example, in regards to a high priority area of interest or event (e.g., accident or emergency), control apparatus 8 and/or MEC device 140 may determine a relatively larger quantity of additional sensor data, relative to additional sensor data identified pertaining to a lower priority area of interest, or sensor data not associated with an area of interest (e.g., pothole).

In certain embodiments, processing circuitry 22 of an example embodiments, such as control apparatus 8 and/or MEC device 140 may determine the additional sensor data based on a frequency at which the additional sensor data is transmitted. Sensor data streamed and/or continuously transmitted, and/or transmitted at a relative frequent interval such as every 10 seconds from the same device 12 may be more desirable than sensor data transmitted on a less frequent interval such as every minute. For an area of interest having a low priority or rating, such as a pothole, processing circuitry 22 may identify additional sensor data that is transmitted weekly, monthly, and/or the like.

Certain example embodiments may further determine the additional sensor type according to at least one sensor type of the at least one additional sensor. For example, control apparatus 8 and/or MEC device 140 may request video sensor data and/or audio sensor data for a high priority area of interest and/or for certain event types. Sensor data from vehicles sensors and/or specific vehicle sensors may be desired when the area of interest relates to a vehicle accident and/or the like.

According to certain example embodiments, processing circuitry 22 of control apparatus 8 and/or MEC device 140 may further determine the additional sensor data based on a desired or target quantity of sensors from which the additional sensor data is transmitted and/or will be transmitted. For example, control apparatus 8 and/or MEC device 140 may seek to obtain sensor data from 20 sensors in the vicinity of the area of interest.

In yet another example embodiment, processing circuitry 22 of control apparatus 8 and/or MEC device 140 may identify additional sensor data according to a rate at the data is or was transmitted. Sensor data transmitted at, or available for transmission at a higher rate, relative to a rate of transmission of other sensor data, may be more desirable for high priority areas of interest (e.g., reflecting an emergency, accident, and/or the like), whereas sensor data transmitted at a lower rate and/or slower rate may be sufficient for lower priority areas of interest. Accordingly the additional sensor data may be identified based on a transmission rate.

Still further, processing circuitry 22 of control apparatus 8 and/or MEC device 140 may identify additional sensor data based on quality of the sensor data. The quality may refer to any characteristic or manner in which the sensor data is captured, stored, encoded, compressed, and/or transmitted. In video and/or image sensor data for example, quality may relate to sharpness, exposure, sharpness, contrast, color shifts, saturation, distortion, and/or the like. For example, if audio sensor data is associated with an area close to the area of interest, a lower quality may suffice, but if the audio sensor data is associated as further from the area of interested, higher quality audio sensor data may be desirable. Additionally or alternatively, sensor data received from the device 12 in a prior instance of time may be analyzed to determine if additional sensor data should be transmitted from the same device (e.g., based on quality of the sensor data provided).

The processing circuitry 22 of example embodiments may select, combine and/or weight various characteristics used to determine the additional sensor data according to various factors such as but not limited to the proximity to the area of interest, a characteristic and/or rating of the area of interest, and/or the like. The additional sensor data may further be identified based on what other sensor data relating to the area of interest may be available. Control apparatus 8 and/or MEC device 140 may determine certain additional sensor even if desired characteristics are not obtainable, if no other sensor data relating to the area of interest is available. Similarly, the control apparatus 8 and/or MEC device 140 may prioritize the transmittal of the additional sensor data based on similar factors, and/or may control, vary, and/or direct such transmission characteristics as described in further detail below.

As shown by operation 406, in certain embodiments, apparatus 20 may include means, such as the processing circuitry 22, memory device 24, communication interface 26, and/or the like for causing a data transmission request to be broadcasted via a local device associated with the area of interest to a plurality of devices. As described above, determination of additional sensors may occur by broadcasting a signal in the vicinity of the area of interest. Processing circuitry 22 of the control apparatus 8 and/or MEC device 140 may direct a local device to broadcast the signal. In certain embodiments, in response to the trigger signal, control apparatus 8 and/or MEC device 140 may transmit a signal to the device 12 from which the first sensor data was received, causing the device 12 to broadcast a signal to other devices in the area. Still further, the control apparatus 8 and/or MEC device 140 may transmit a signal to a local device, such as a server and/or hub, which may in turn broadcast a signal to other devices and/or apparatuses in the vicinity, such as smart phones, vehicles, and/or the like. The location of such a local device may be identified based on geographic attributes, map matched data and/or the like such that the local device is associated with the geographic area of interest. For example, control apparatus 8 and/or MEC device 140 may access a list or database of pre-defined, fixed, permanent, or semi-permanent devices and associated locations of local devices such as servers, hubs, and/or the like. In this regard, the at least one additional sensor may be determined according to devices within range of a local device that receives direction from control apparatus 8 and/or MEC device 140 to broadcast the data transmission request. According to certain embodiments, such as when a certain threshold of determination of an area of interest is satisfied by processing sensor data on the device 12, the device 12 of example embodiments may cause the broadcasting of the data transmission request.

In certain example embodiments, although a broadcasted data transmission request may be transmitted to any device 12 capable of receiving the signal, the data transmission request may indicate requested characteristics of sensor data to be transmitted. For example, the processing circuitry 22 of an example embodiment may configure a data transmission request to request data from devices that are in specific locations relative to an area of interest and/or an event (e.g., different angle of an accident), and/or that can provide particular characteristics such as any of (a)-(f) described above. For example, the control apparatus 8 and/or MEC device 140 may seek higher quality image data for an accident, but settle for low quality image data for a social gathering. In certain example embodiments, the data transmission request could indicate specific type of data dependent on the event and/or area of interest (e.g., audio data for a social gathering, and temperature data for a natural disaster).

As shown by operation 408, in certain embodiments, apparatus 20 may include means, such as the processing circuitry 22, memory device 24, communication interface 26, and/or the like for causing transmission of a request for consent to a user device associated with at least one unenrolled sensor associated with the area of interest. An “unenrolled” sensor may refer to a lack of authorization by a user of the device 12 associated with the sensor 10 and/or associated sensor data, to provide sensor data to apparatus 20. If it is determined the additional sensor and/or corresponding device 12 is already enrolled or associated with a user who has already given consent, or that consent is not required, operation 408 may be omitted or bypassed. In any event, if a request for consent is transmitted, associated content may be displayed via user interface 28 of a device 12 associated with the additional sensor such that a user can accept or decline the request.

In operation 410, apparatus 20 may include means, such as the processing circuitry 22, memory device 24, communication interface 26, and/or the like for receiving an indication of the consent via the user device, wherein the at least one additional sensor is associated with the user device. In this regard, control apparatus 8 and/or MEC device 140 may initiate or control transmission of sensor data from a potentially identified additional sensor that was not previously enrolled and/or approved for data transmission. Such consent and/or authorization may be optionally enforced according to certain embodiments prior to transmission of additional sensor data. If consent is not authorized, the sensor data may not be transmitted from the respective device 12.

Certain operations of FIG. 4 may be considered optional. In any event, various methods may be utilized for the processing circuitry 22 of an example embodiment to determine, in response to the trigger signal, at least one additional sensor associated with the area of interest. Returning to the description of FIG. 3, and operation 302 the additional sensor data from at least one additional sensor may be transmitted via a communication interface 26 of device 12 and/or service device 14, and via a communication interface 26 of the control apparatus 8 and/or MEC device 140. Accordingly, the control apparatus 8 and/or MEC device 140 may communicate with a device 12 associated with the at least one additional sensor associated with the area of interest to direct the transmission of additional sensor data (e.g., different than the first sensor data).

In this regard, if consent has been given and/or is not needed, the control apparatus 8 and/or MEC device 140 may collect additional sensor data relating to the area of interest (and/or event) as directed by processing circuitry 22. It will be appreciated that the transmission of the additional sensor data occurs responsive to the trigger signal, and may therefore be independent of any routine data transmission process of the sensor data to the control apparatus 8 and/or MEC device 140. If sensor data from a device 12 is transmitted therefrom to the control apparatus 8 and/or MEC device 140 as a part of routine data exchange and/or transmission, the trigger signal may trigger transmission of the additional data independently of any such routine collection and/or process, such as at an earlier time than scheduled. Accordingly, in certain embodiments, the additional sensor data is transmitted to the control apparatus and/or MEC device 140 in real-time or near real-time responsive to determining an area of interest.

In certain embodiments, in regards to operation 302, processing circuitry 22 of apparatus 20 may prioritize, or direct prioritization of transmission of the additional sensor data in a variety of ways. Accordingly, in operation 304, which may be optional as indicated by dashed lines in the flowchart, and which may occur in conjunction with, before, or after operation 302 and/or operation 306, apparatus 20 may include means, such as the processing circuitry 22, memory device 24, communication interface 26, and/or the like for in response to the trigger signal, prioritizing the transmission of the additional sensor data. The prioritization may occur based on various factors or characteristics such as but not limited to (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted. In this regard, prioritization based on any characteristics (a)-(f) may be performed based on sensor data already captured at the device 12 and may optionally be based on or limited by capabilities of the device 12 and/or as limited or restricted by a user of the device 12. Additionally or alternatively, transmission of sensor data may be prioritized based on proximity of the additional sensor (e.g., in real-time or near real-time, or a time at which sensor data was collected) to the area of interest, a characteristic and/or rating of the area of interest, and/or the like.

Additionally or alternatively, processing circuitry 22 may direct, vary, and/or control any transmission characteristics, such as but not limited to characteristics (a)-(f), such as set forth by operation 306. In operation 306, which may occur in conjunction with, before, or after operation 302 and/or operation 304, apparatus 20 may include means, such as the processing circuitry 22, memory device 24, communication interface 26, and/or the like for controlling (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted. For example, determination of any of the characteristics such as characteristics (a)-(f) may be based on proximity to the area of interest, a characteristic and/or rating of the area of interest, and/or the like. The MEC device 140 may further determine, vary, and/or direct control of the characteristics (a)-(f).

The quantity may refer to the number of readings from a sensor, number of captured images, duration of video signals, duration of audio signals and/or the like. For example, in regard to a high priority area of interest or event, a relatively larger quantity of sensor data may be collected relative to sensor data collected pertaining to a lower priority area of interest, or sensor data not associated with an area of interest.

In certain embodiments, prioritization of transmittal of the additional sensor data may refer to varying a frequency at which the additional sensor data is transmitted and/or frequency may be directed, varied, and/or directed. According to certain embodiments, processing circuitry 22 may direct sensor data to be streamed and/or continuously transmitted. However in certain embodiments, certain sensors reading and/or images may be captured and/or transmitted on a particular time interval such as every second of every 10 seconds. For an area of interest having a low priority or rating, such as a pothole, sensor data may be transmitted weekly, monthly, and/or the like.

Processing circuitry 22 of certain example embodiments may further prioritize transmission of sensor data according to at least one sensor type of the at least one additional sensor. For example, video sensor data captured from a dashboard camera may be prioritized over video sensor data captured from a mobile device camera. Application data, device data, and/or sensor data may be used to determined sensor types and/or related characteristics. Video sensor data may be prioritized over audio sensor data. Various other prioritizations based on sensor type may be contemplated. In certain embodiments, first sensor data associated with one type of sensor, may trigger sensor data collection associated with another type of sensor.

According to certain example embodiments, control apparatus 8 and/or MEC device 140 may further prioritize transmission of sensor data according to a quantity of the additional sensors by which the additional sensor data is transmitted. For example, control apparatus 8 and/or MEC device 140 may seek to obtain video sensor data from 20 sensors in the vicinity of the area of interest. Once sensor data associated with 20 sensor sources have been identified and/or received, example embodiments may allocate associated resources to collect sensor data from devices not associated with the area of interest.

In yet another example embodiment, processing circuitry 22 of control apparatus 8 and/or MEC device 140 may further prioritize transmission of sensor data according to a rate at the data is transmitted, and/or may vary, control, and/or direct data transmission rates. Sensor data relating to a high priority area of interest (e.g., reflecting an emergency, accident, and/or the like), may be transmitted at a higher rate (e.g., transfer rate and/or bit rate) relative to sensor data associated with a lower priority area of interest (e.g., potholes, social gatherings and/or the like), or not associated with an area of interest.

Still further, the processing circuitry 22 of an example embodiment such as control apparatus 8 and/or MEC device 140 may prioritize transmission of sensor data based on quality of the sensor data based on any of the proximity to the area of interest, characteristic and/or rating of the area of interest. The quality may refer to any characteristic or manner in which the sensor data is captured, stored, encoded, compressed, and/or transmitted. In video and/or image sensor data for example, quality may relate to sharpness, exposure, sharpness, contrast, color shifts, saturation, distortion, and/or the like. The quality may be assessed by accessing device data relating to the type of camera sensor and/or other sensor used. Additionally or alternatively, example embodiments, such as via application code running on the device 12 may access properties indicative of quality prior to transmission such that transmission may be prioritized accordingly. As yet another example, sensor data received from the device 12 in a prior instance of time may be analyzed to determine if additional sensor data should be transmitted from the same device (e.g., based on quality of the sensor data previously provided).

The description and characteristics (a)-(f) are provided as examples and many variations may be contemplated. Different weights of such characteristic may be updated in real-time or near real-time to re-prioritize data transmission according to various factors, including characteristics (a)-(f), and/or availability of other sensor data and their respective characteristics (a)-(f), shifting interest levels, new detected area of interest, and/or the like.

Further in response to the trigger signal, in operation 308, apparatus 20 may include means, such as the processing circuitry 22, memory device 24, communication interface 26, and/or the like for deprioritizing, terminating, and/or preventing other data transmission. As certain sensor data is prioritized, control apparatus 8 and/or MEC device 140 may deprioritize, terminate and/or prevent transmission of other data based on resource availability and/or demands relating to the additional sensor data and/or higher priority sensor data. In this regard, transmission of lower priority sensor data, such as data relating to social gatherings, road conditions and/or the like may be terminated, and/or postponed until a later time, in response to a trigger signal indicating an area of interest. As interest levels of a certain area increase, or as new areas of interest are detected, other data transmission may be deprioritized, terminated, and/or postponed. Example embodiments may therefore advantageously control, direct, and/or vary the timing of transmission of certain sensor data, and therefore improve and/or optimize the performance of certain operations performed within a related network, as well as improve and/or optimize the utilized of certain network resources.

In certain embodiments, further in response to the trigger signal, in operation 310, apparatus 20 may include means, such as the processing circuitry 22, memory device 24, communication interface 26, and/or the like for transmitting the additional sensor data to at least one remote device, such as remote devices 180. In this regard, the additional sensor data (and optionally the first sensor data) may be transmitted from a control apparatus 8 and/or MEC device 140 to a core network such as core network 160. The core network 160 may further facilitate transmission of the additional sensor data and/or first sensor data to remote devices 180, which may optionally provide the sensor data via a user interface 28. Sensor data such as audio sensor data, video sensor data and/or the like may be provided, and in some instances may be provided in near real-time relative to identification of the area of interest based on the first sensor data, subsequent collection of additional sensor data, and/or the like, such that users may be provided with relevant sensor data within seconds of capture of an area of interest.

Additionally or alternatively, the sensor data may be provided from a diverse set of sensors and/or related apparatuses, diverse set of sensor types, and/or from different perspectives, angles, and/or the like. Accordingly, certain example embodiments may further facilitate scene assessment and/or scene reconstruction processes and enable realistic virtual immersion in certain scenes and/or environments, and therefore improved user experience. Example embodiments provided herein may additionally or alternatively be utilized in autonomous driving systems such as but not limited to autonomous driving decision making.

According to certain example embodiments, indications of the area of interest, but not necessarily the sensor data, may be transmitted to a remote device 180. For example, an alert signal may be transmitted, such as an alert signal indicative of the area of interest and/or associated event, such as an accident, crime, fire, weather event, and/or the like. In this regard, sensor data from multiple devices may be advantageously utilized to trigger notification to remote systems and/or devices. Example embodiments may therefore trigger the deployment of emergency vehicles and/or the like. As another example, the information may be utilized in targeted advertising, smart city analytics, determining and/or verifying driving and/or population counts, and/or the like. As another example, sensor data collected and monitored over time may indicate deteriorating road conditions and/or the like and may enable control apparatus 8 and/or MEC device 140 to notify related remote devices 180.

According to certain example embodiments provided herein, processing circuitry 22 of control apparatus 8 and/or MEC device 140 may facilitate the provision of pertinent sensor data to users in a more efficient manner than is achieved without the advantages of example embodiments, by allocating and/or reserving certain network resources for data transmission related to areas of interest and/or associated events, while optionally reducing network resources utilized by other processes and/or transmission of lower priority sensor data and/or sensor data not associated with an area of interest. The sensor data may therefore be delivered to end users with relatively low-latency, or lower latency than what may be achieved without the advantages of example embodiments provided herein, thereby providing an improved user experience and/or timely delivery which may be vital in triggering emergency signals and/or collection of further sensor data. Example embodiments provided herein may also therefore improve the efficiency of such systems, optimize and/or improve the utilization of resources in a network, and/or the like.

Still further, certain functionality of example embodiments may be implemented at a device 12 (with application code operative on the device 12, for example), while some portions may be implemented at the control apparatus 8 and/or MEC device 140. Application developers and network developers may adjust and/or redistribute certain functionality amongst certain components accordingly. For example, some resource intensive processing of sensor data may be more efficiently implemented at the control apparatus 8 and/or MEC device 140, while some processing of sensor data may be effectively and efficiently performed at the device 12, to potentially reduce data transmissions from device 12, and/or unnecessary further processing by the control apparatus 8 and/or MEC device 140 of sensor data of low or no interest. The utilization and/or timing of utilization of certain resources, such as processing and/or memory resources of the control apparatus 8, MEC device 10, and/or resources of the related network(s), such as transmission bandwidth and/or the like, may be conserved, optimized, and/or improved in comparison to systems that do not implement the example embodiments provided herein.

Example embodiments provided herein may therefore enable relative low latency collection of sensor data at times of need, and in areas of interest, rather than relying on frequent or continuous collection of data from all available sources, which may otherwise be expensive from a standpoint of computational resource consumption and/or the like. Moreover, example embodiments could enable real-time and/or near real-time (e.g., instantaneous and/or timely) collection of data from a diverse set of devices, which may have different types of sensors, sensor qualities, and/or the like, and could provide data about the area of interest and/or event from various perspectives (e.g., a plurality of perspectives).

FIGS. 3 and 4 are flowcharts depicting a method according to an example embodiment of the present invention. It will be understood that each block of the flowchart and combination of blocks in the flowchart may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus 20 employing an embodiment of the present invention and executed by the processing circuitry 22. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least processing circuitry and at least one non-transitory memory comprising computer program code instructions, the computer program code instructions configured to, when executed by the processing circuitry, cause the apparatus to:
generate a trigger signal in response to identifying an area of interest based on first sensor data provided by at least a first sensor of a first device; and
in response to the trigger signal, identify at least a second device as associated with the area of interest based on location data received from the second device, and cause transmission of additional sensor data provided by at least one additional sensor of the second device associated with the area of interest.

2. The apparatus according to claim 1, wherein identifying an area of interest comprises identifying an event of interest in the area of interest, and wherein the trigger signal is generated in response to identifying the event of interest in the area of interest.

3. The apparatus according to claim 1, wherein the first sensor data is transmitted via a routine data transmission process associated with the at least first sensor, and wherein the additional sensor data is transmitted independently of any routine data transmission process associated with the at least one additional sensor.

4. The apparatus according to claim 1, wherein the transmission of additional sensor data occurs in real-time or near real-time relative to the identification of the area of interest.

5. The apparatus according to claim 1, wherein the computer program code instructions are further configured to, when executed by the processing circuitry, cause the apparatus to:
in response to the trigger signal, identify the additional sensor data by processing a temporal characteristic of at least one of the first sensor data or the additional sensor data.

6. (canceled)

7. The apparatus according to claim 1, wherein the computer program code instructions are further configured to, when executed by the processing circuitry, cause the apparatus to:
prioritize transmission of the additional sensor data over other sensor data, based on at least one of an associated proximity of a respective additional sensor to the area of interest, or a characteristic of the additional sensor data, wherein the characteristic of the additional sensor data comprises at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

8. The apparatus according to claim 1, wherein the computer program code instructions are further configured to, when executed by the processing circuitry, cause the apparatus to:
control at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

9. The apparatus of claim 1, wherein the computer program code instructions are further configured to, when executed by the processing circuitry, cause the apparatus to:
identify the additional sensor data based on at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

10. The apparatus according to claim 1, wherein the computer program code instructions are further configured to, when executed by the processing circuitry, cause the apparatus to:
identify the additional sensor data based on a camera angle relative to the area of interest.

11. The apparatus according to claim 1, wherein the computer program code instructions are further configured to, when executed by the processing circuitry, cause the apparatus to:
further in response to the trigger signal, cause transmission of a request for consent to a user device associated with at least one unenrolled sensor associated with the area of interest; and
receive an indication of the consent via the user device, wherein the at least one additional sensor is associated with the user device, and wherein the transmission of the additional sensor data occurs in response to receiving the indication of the consent.

12. The apparatus according to claim 1, wherein the computer program code instructions are further configured to, when executed by the processing circuitry, cause the apparatus to:
further in response to the trigger signal, deprioritize, terminate, or prevent other data transmission.

13. The apparatus according to claim 1, wherein the computer program code instructions are further configured to, when executed by the processing circuitry, cause the apparatus to:
identify at least a second area of interest associated with second sensor data; and
prioritize transmission of data associated with the area of interest differently than transmission of data associated with the second area of interest based upon respective characteristics or ratings of the area of interest and the second area of interest.

14. The apparatus of claim 1, wherein the apparatus is an edge computing device implemented closer to the first device and the second device than an infrastructure of a core network with which the edge computing device communicates.

15. The apparatus of claim 14, wherein the computer program code instructions are further configured to, when executed by the processing circuitry, cause the apparatus to:
transmit the additional sensor data via the core network to one or more remote devices.

16. The apparatus of claim 1, wherein the computer program code instructions are further configured to, when executed by the processing circuitry, cause the apparatus to:
further in response to the trigger signal, cause a data transmission request to be broadcasted, via a local device associated with the area of interest, to a plurality of devices; and
identify the at least one additional sensor in response to the broadcast, wherein the transmission of additional sensor data provided from the at least one additional sensor is performed in response to the broadcast.

17. A method comprising:
generating a trigger signal in response to identifying an area of interest based on first sensor data provided by at least a first sensor of a first device; and
in response to the trigger signal, identifying at least a second device as associated with the area of interest based on location data received from the second device, and causing transmission of additional sensor data provided by at least one additional sensor of the second device associated with the area of interest.

18. The method of claim 17, further comprising:
prioritizing transmission of the additional sensor data over other sensor data, based on at least one of an associated proximity of a respective additional sensor to the area of interest, or a characteristic of the additional sensor data, wherein the characteristic of the additional sensor data comprises at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

19. The method of claim 17, further comprising:
controlling at least one of (a) a quantity of the additional sensor data transmitted, (b) a frequency at which the additional sensor data is transmitted, (c) at least one sensor type of the at least one additional sensor, (d) a quantity of the additional sensors by which the additional sensor data is transmitted, (e) a rate at which the additional sensor data is transmitted, or (f) a quality of the additional sensor data transmitted.

20. A computer program product comprising at least one non-transitory computer-readable medium having computer-readable program instructions stored therein, the computer-readable program instructions comprising instructions, which when performed by an apparatus, are configured to cause the apparatus to:
generate a trigger signal in response to identifying an area of interest based on first sensor data provided by at least a first sensor of a first device; and
in response to the trigger signal, identify at least a second device as associated with the area of interest based on location data received from the second device, and cause transmission of additional sensor data provided by at least one additional sensor of the second device associated with the area of interest.

21. The apparatus according to claim 8, wherein at least one of (a) the quantity of the additional sensor data transmitted, (b) the frequency at which the additional sensor data is transmitted, (c) the at least one sensor type of the at least one additional sensor, (d) the quantity of the additional sensors by which the additional sensor data is transmitted, (e) the rate at which the additional sensor data is transmitted, or (f) the quality of the additional sensor data transmitted is controlled based on a proximity of the second device to the area of interest as indicated by the location data received from the second device.
